(19) United States
(12) Patent Application Publication
(10) Pub. No.: US 2003/0223219 A1
(43) Pub. Date: Dec. 4, 2003

(54) Chemiluminescent illuminating elements

(76) Inventor: Jacques Ladyjensky, Bruxeller (BE)

Correspondence Address: McHale & Slavin, 4440 PGA Blvd Suite 402, Palm Beach Gardens, FL, 33410, US

(21) Appl. No.: 09/914,513

(22) PCT Filed: Aug. 28, 2001
(86) PCT No.: PCT/BE01/00040

(30) Foreign Application Priority Data
Mar. 10, 2000 (BE) 2000/0195

(51) Int. Cl. F21K 2/06; B65D 25/08

(52) U.S. Cl. 362/34; 206/219; 206/222

(57) ABSTRACT

The invention concerns a chemiluminescent illuminating element comprising two containers filled respectively with an oxalate solution (5) and an activating solution. The oxalate solution is in a sealed pouch (1) made of a thin film (2,3) of aluminium foil, on the inside, and a polymer, for instance polyolefin, thereby forming the first container. The latter is enclosed in a larger sealed pouch (6) made of translucent polymeric film (7,8), forming the second container, which also contains the liquid activator (10). The outer pouch consists of two polymeric films (7,8) sealed together at their periphery and contains a ball (11) capable of tearing open the inner pouch (1) by the user's manual action.

Devices able to emit light by the mixing of two liquid chemicals are well known. May be cited the following U.S. Pat. Nos. 3,539,794, 3,576,987, 4,193,109, 4,682,544, 4,751,616, 4,814,949 and 5,121,302.

Generally speaking the proposed devices involve two chambers, respectively containing the first liquid chemical, named oxalate solution, and the second one, named activator solution. These two chambers being separated by a wall which can be broken by the user, or having a removable part. Said wall should also be a good barrier against gases, because the oxalate solution is sensitive to any contamination originating either from outside or from the activator. Therefore, in practice, save economically costly exceptions, the oxalate solution is enclosed in a beakable glass ampoule. Unfortunately, it is not possible to continuously manufacture, starting from material in roll form, elements with glass ampoules. Moreover, they are expensive.

The present invention relates to an element idoneus for such a continuous manufacture, thus very economical, and what is more, with constitutive materials being very cheap. The element has furthermore the advantage of being flat, of being particularly light, as well as other auxiliary advantages which will appear in the following expose.

More particularly, the invention proposes a chemiluminescent lighting element involving at least two chambers filled respectively with an oxalate solution and an activator solution. The oxalate solution is in a tight-closed pouch of thin aluminum foil, lined on its interior side by a polymer, said pouch being a first chamber. This pouch is itself enclosed in a bigger tight-closed pouch, made of translucent polymeric film, being a second chamber, which also contains the liquid activator chemical.

The element according to the invention is then essentially comprising a pouch made of aluminum foil containing the oxalate solution, disposed inside a pouch made of translucent plastic film, containing also the activator solution, and, optionally, an absorbing felt and a steel ball or other hard particle, of which the role is to pierce the aluminum pouch at the moment of use, under the effect of manipulating by the user.

The invention will be better understood with reference to the annexed drawings, shown as examples. In these drawings:

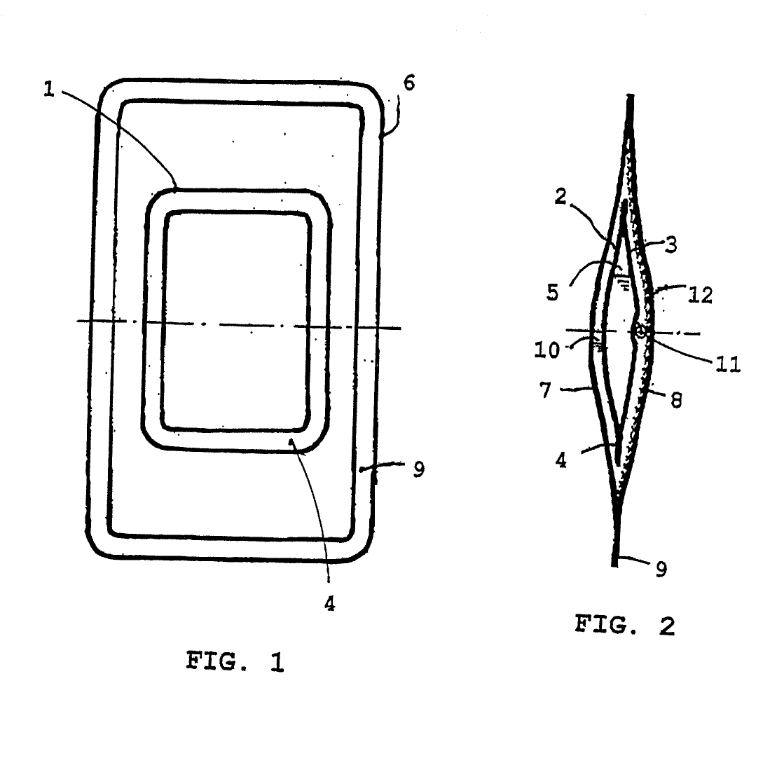

FIG. 1 represents a top plan view of the device according to the invention;

FIG. 2 is a cross-sectional view of same;

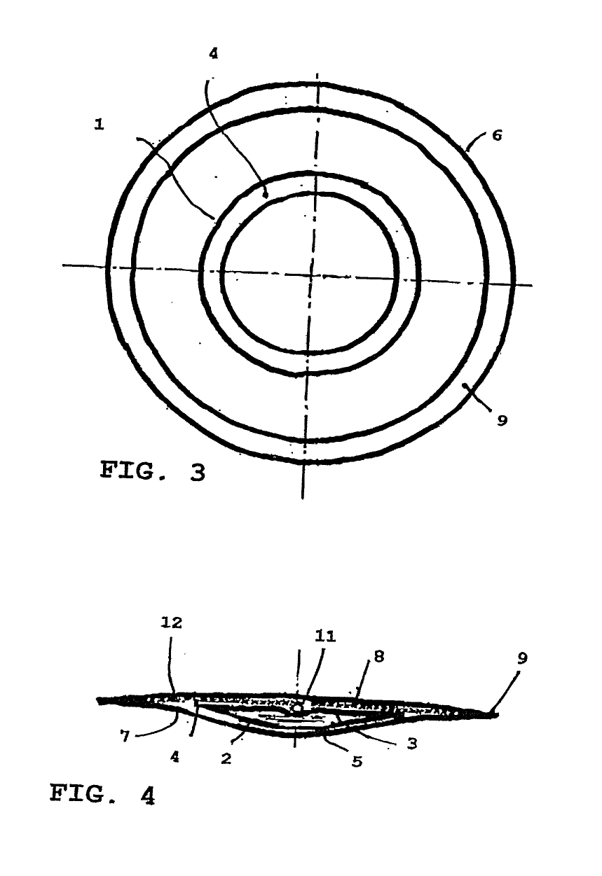

FIG. 3 is a top plan view of another embodiment of the invention, and

FIG. 4 is its matching cross-sectional view.

The inner pouch 1 is made of the two aluminum foils 2 and 3, sealed together along their periphery 4,—rectangular in the FIGS. 1 and 2, and circular in the FIGS. 3 and 4.

It contains the oxalate liquid chemical solution, of which the level is shown as 5. The outer pouch 6 is made of two films 7 and 8, of translucent soft polymer, preferably polyolefin, for instance polyethylen or polypropylene, sealed along a periphery 9,—rectangular in the FIGS. 1 and 2, and circular in FIGS. 3 and 4. It contains the activator liquid of which the level is figured as 10.

The device involves, optionally, a steel ball 11 or a hard particle on which the user will push in order to pierce the aluminium pouch, and so induce the mixing process. It can also be conceived, that this ball or particle be not used, and that the pouch will be bursted by pressure. In that case, it is suitable to foresee an area of weakened resistance, for instance a welding line. Each of the two aluminium foils is lined, by coating, laminating, or other technique, by a coat of polymeric lacquer, on this one of their surfaces which is to be faced to the corresponding one. This lacquer coat, preferably based on a polypropylene, modified or not, is provided to ensure the adhesion of the two foils together by thermal sealing along their periphery. This coat is not represented on the drawings for reasons of clarity.

This polymeric coat, in addition to adhesion, has also the role of insuring a good compatibility between aluminium material and the oxalate solution which is delicate and sensitive to contaminations, and is compatible with only few materials. This coat is very thin, in order not to increase the mechanical resistance of the aluminium, which is due to become broken.

In addition to this coat, it is possible to also foresee the presence of a thin soft film of polypropylene between the two aluminium foils. It will be prisoner between them by the sealing and will contribute to the quality of said sealing. It is not represented on the drawings, for reasons of clarity. Of course the oxalate solution will be between this soft film and one of the aluminium foils, the one to be pierced.

The device involves also, optionally, a felt 12 (succession of small crosses on the drawings) made of nonwoven material of which the fibers are preferably from the same polymer as the films of the outer pouch. It will be prisoner between the two films by the peripheral thermal sealing. During the storage of the lighting element before use, this felt will have time to absorb the whole of the activator liquid and spread it uniformly in the pouch. The result will be a good uniformity in emitted light after the liberation of the oxalate solution, because the two chemical liquids are avid to diffuse into each other within a short time. The level of activator liquid as figured in 10 in FIG. 2, is the one met at the time of filing; later, it will be absorbed in the felt as said above.

Once emptied, or almost emptied, the aluminium pouch remains in place and has a role of reflector; the whole of luminous emission takes place indeed from the same side of the aluminium pouch,—the pierced side. There is almost no liquid at the other side. This intense unidirectional emission of light is incontestably an advantage towards prior art in the matter.

It is frequent that the inner pouch be not entirely emptied by the user at the time of lighting-up. It has been seen that some rests were remaining inside because of some creases or other reasons. It is then advantageous, while the light is weakening with the hours, due to the unavoidable chemical energy consumption of the system, to handle the element with some kneading action, in order to extract the remains of oxalate solution contents out of the inner pouch. One can then see a kind of regeneration of the luminous emission, and this, at the moment decided by the user. This is an appreciable advantage versus the prior art, vainly asked for, until now, by the market.

In FIGS. 1 and 2 the element is figured under a rectangle form, and in FIGS. 3 and 4, under a circular form, but of course the peripheral sealing can have any other form, and, particularly, for advertising or promotional purposes, be made under the form of a brand logo.

For industrial manufacture, it is foreseen, with use of a “fill-and-seal” type of packaging machine, to unroll, from their respective storage rolls, the two aluminium foils, as well, if any, the optional roll of soft polymer film, in order to present face to face the coated sides of these aluminium foils, and to seal successively the pouches in a continuous and temporized way.

When the aluminium foils are face to face, one of them—or both—is slightly embossed by a small punching tool, mechanically actuated, this in view of creating some volume for the liquid to be received. Then the injection of oxalate solution is done, followed by the pouch sealing. Once sealed, the pouches are separated by means of an automated knife, and fall individually into the second machine, described hereafter.

The machine can be of vertical type, as suggested by FIGS. 1 and 2, or of horizontal type, as suggested by FIGS. 3 and 4. The embossing operation is easier in horizontal machine and can be done on the inferior foil only.

The aluminium foils have been coated or laminated with the polymeric lacquer mentioned hereabove, in the course of a previous operation, which has also be done continuously by known means.

A second machine, also of the “fill-and-seal” type, receives in a sequential way, synchronously with the first machine, the filled and sealed aluminium pouches, and seals together the two soft plastic films, as well as the felt if any, all three of them being continuously unrolled from their storage rolls. Before sealing, a measured quantity of activator liquid is introduced, as well as the ball.

It is important to note that in this second machine, which manufactures the outer pouches (and this, contrarily to what happens in the first machine with the aluminum foils) the two films of flexible plastic, unrolled in view of the operation, remain flat, i.e. not “embossed” or “deepdrawn” until the moment of final sealing. They then take a slightly swollen structure because at the sealing time, they cage between them the aluminium pouch. This swelling is a purely elastic deformation, with tensioning, due to the natural elasticity of the films, by nature reversible. As a result the walls of the outer pouch exert on the inner pouch and its contents, an uniform elastic pressure of which the action is very favorable at the moment of piercing by the user. The oxalate liquid is then ejectioned with force, what favours the desired mixing.

The completed pouches then go out from the exit of the machine under the form of a chain, or sausage chain, and can be supplied as such to the user, if he is interested by light “in-line”,—a novel item being of interest for instance for police or army forces.

Of course the pouches can be separated from each other by means of an automated knife, or by weakened lines—precut lines—for ulterior separation by the user himself.

### EXAMPLES OF EMBODIMENTS

### Example 1

In this example, it is made use of a vertical machine, of modified “fill-and-seal” type. The used aluminium foil is of Reynolds brand, in tape of 35 mm width, and 300 meter long rolls. Thickness is 28 micrometer for the face to be pierced and 38 micrometer for the other one.

Before being slit into rolls of 35 mm width, said foil has been coated on its full width −600 mm—with polypropylene dispersion, and cured in a tunnel oven. The remaining deposited thickness after cure is 6 micrometer.

When the two aluminium foils are face to face, their mutual sealing is done along a rectangular periphery of 33×65 mm except on the upper side, through which an embossing finger mechanically penetrates accompanied with a needle for injection of the oxalate solution, then these two elements withdraw, and the sealing is completed.

The oxalate solution consists of a dibutylphthalate solvent in which, per liter, are dissolved 120 grams of CPP oxalate and 1.5 gram of DPEA dye. These components are well-known in the prior art in matter of chemiluminescent elements.

The ball is a bearing ball, of third choice, diameter 4.5 mm.

The films in the outer pouch are of copolymer polypropylene-polyethylene without slip-agent in the formula, thickness 0.25 mm, in rolls of 40 mm width, 300 m length.

The measured quantities of oxalate solution and activator solution are respectively 1.7 and 0.7 milliliter.

Sealings are done by jaws or anvils having the shape of rectangles with rounded corners, with an effective sealing width of 2 mm. The thermal energy for the sealings is brought either by electrical resistances or via an ultrasonic generator.

The felt is a nonwoven “spunbond” film of polypropylene and polyethylene fibers, of 120 grams per square meter.

The completed items, separated by an automatic temporized knife, have a dimension of 45×70 mm and a weight of 4 grams.

### Example 2

The process is same as in Example 1, but with use of an horizontal type machine. The embossing of the lower aluminium foil is done by lowering a punching tool prior to any sealing; then the depositing of the liquid chemical is done with a removable needle, thus the sealing between the two aluminium foils is done in one shot along the whole periphery.

In this case the aluminium tapes feeding the machine have a width of 41 mm, and those of flexible plastic film, a width of 65 mm. Quantities or oxalate solution and activator solution are respectively 2.2 and 1.1 milliliter. Completed items have a diameter of 59 mm and a weight of 5 grams.

1. Chemiluminescent lighting element, comprising at least two chambers filled respectively with an oxalate solution and an activator solution, characterized in that the oxalate solution takes place in a tight-closed pouch, made of thin aluminium foil, lined on its interior side by a polymer, said pouch being a first chamber, being itself enclosed in a tight-closed pouch, bigger, made of translucent polymeric film, being a second chamber, containing also the liquid activator solution.

2. Element according to claim 1 in which the polymer lining the aluminium foil is a polyolefin.

3. Element according to claim 1 or 2 in which the outer pouch consists of two polymeric films sealed together along their periphery.

4. Element according to claim 3 in which one of the two polymeric films is lined, on its internal side, by a felt or fabric made of absorbing material and compatible with the oxalate and activator solutions.

5. Element according to claim 3 in which the films are under elastic tension.

6. Element according to claim 1, 2 or 3 in which the outer pouch contains also one or several particles of hard material.

7. Element according to claim 4 in which the particle of hard material is a steel ball.

8. Element according to claim 4 in which the particle or particles of hard material are polyolefin granulates.

9. Element according to anyone of the above claims in which the inner pouch consists of aluminium foils lined of polymer, and in which the sealing has areas of lesser resistance to bursting.

10. Manufacturing process of a chemiluminescent lighting element, according to anyone of claims 1 to 9, in which pouches made of thin aluminum foil lined with polymer are formed in a continuous and sequential way, by the unrolling of two rolls of aluminium tape brought against each other, polymer face in contact, and sealed at least along a periphery, with injection of oxalate solution inside the periphery delimited by the sealing,
said pouches sealed and filled in that manner, are separated by an automated knife and sent one by one, in a sequential and temporized way, to a second machine which incorporates them in a pouch of translucent plastic,
said second machine doing the face-to-face positioning of two tapes of flexible translucent polymer film, unrolled from storage rolls, and sealed along periphery with insertion of the aluminium pouch and of the activator solution inside said periphery, the whole of which being done in a continuous and temporized way,
the final completed pouches being then either separated from each other by means of an automated knife into series of individual pouches, or supplied to end-user as a chain as gone off from the machine.

11. Manufacturing process according to claim 10, in which one of the two tapes of flexible translucent polymer film is lined, on the face aimed towards the other polymer tape, by a tape made of absorbing fiber felt, and is continuously sealed to the nonlined flexible polymer film tape which faces it.

12. Manufacturing process according one of the claim 11 or 10, characterized in that, at that moment of inserting the aluminium pouch and the activator solution, one or several hard particles are also inserted between the two pouches.
The invention relates to a chemiluminescent light element comprising two chambers, filled respectively with an oxalate solution (5) and an activator solution. The oxalate solution is a tight-sealed pouch (1) made of thin aluminum foil (2, 3) lined on its interior side by a polymer, for instance a polyolefin, and so forms the first chamber. This latter is enclosed in a bigger tight-sealed pouch (6) made of translucent polymer film (7, 8) forming the second chamber, which also contains the liquid activator (10). The outer pouch consists of two polymer films (7, 8) sealed together along their periphery and contain a ball (11) able to pierce the inner pouch (1) by manual action from the user.
